(19) United States
(12) Patent Application Publication
(10) Pub. No.: US 2001/0032175 A1
(43) Pub. Date: Oct. 18, 2001

(54) System and method for an on-line industry auction site

(76) Inventors: G. David Holden, Kingsport, TN (US); David G. Fox, Kingsport, TN (US)

Correspondence Address: CHARLES J. CALKINS, KILPATRICK STOCKTON LLP, 1001 WEST FOURTH STREET, WINSTON SALEM, NC, 27101-2400, US

(21) Appl. No.: 09/842,177

(22) Filed: Apr. 26, 2001

Related U.S. Application Data
(60) Provisional application No. 60/200,064, filed on Apr. 27, 2000.

(51) Int. Cl. G06F 17/60

(52) U.S. Cl. 705/37; 705/26; 705/27

(57) ABSTRACT

A method and system for providing an on-line auction, which may be part of a larger on-line community, for conducting and facilitating transactions in a commodity goods marketplace or industry. An embodiment of the present invention provides a World Wide Web (“Web”) based auction site for conducting and facilitating transactions in an industry. The auction-based model allows a supplier to sell or buy goods closer to a real market price than the current method of offering the commodity via telephone, facsimile, or electronic mail (e-mail). The users receive automatic e-mails notifying them of the status of an auction. E-mails and on-line screens show time of day information in a user's local time zone. The end time of auction is automatically extended when there is activity close to the prescheduled end time. Both forward and reverse auctions are enabled.

### CROSS-REFERENCE TO RELATED APPLICATIONS

This application claims priority to U.S. Provisional Patent Application Ser. No. 60/,200,064 filed Apr. 27, 2000 by David G. Fox, entitled “Industry Auction Site,” the entire subject matter of which is herein incorporated by reference.

### BACKGROUND OF THE INVENTION

1. Field of the Invention

The present invention relates to a system and method for conducting and facilitating transactions in a commodity goods marketplace or industry. An embodiment of the present invention provides a World Wide Web (“Web”) based auction site for conducting and facilitating transactions in an industry.

2. Description of the Related Art

The terminology “commodity goods” is generally used to refer to goods, including manufactured goods, supplies, chemicals, parts and the like that are sold in large quantities, generally at low unit prices. For example, in the chemical industry, certain polymers, that are widely utilized by manufacturers are considered commodity goods. Examples of such commodity polymers include, but are not limited to, PET (polyethylene terephthalate), polypropylene, EVA (ethylene vinyl acetate), PVC (polyvinyl chloride), polyethylene, and similar polymers that are sold in bulk at low unit (e.g. per lb.) prices.

Due to the imprecise nature of supply and demand in a commodity good industry, there are often quantities of commodity goods available from producers that are not destined for sale to a particular customer. For example, in the chemical industry, a commodity polymer a producer may have an excess supply of PET.

In addition, due to the imprecise nature of supply and demand, a consumer of commodity goods may have a demand for a good that their existing supply chain is not able to meet. For example, a user of PET may have a demand for PET that is not being met by their ordinary suppliers.

The method currently used by commodity suppliers to sell an overstock of a commodity is to call customers or known users of the commodity and offer it for sale. Typically, a sales representative will first create a list of potential buyers and the proceed to call each potential buyer and offer the commodity for sale. The sales representative will typically call each prospect on the list until the entire overstock of commodity has been sold. With this strategy, the seller could end up selling the commodity for less than its current market value.

For instance, Supplier A has 10 tons of commodity C1. A list of prospects is created: P1, P2, . . . , Pn. Supplier A offers the 10 tons for sale at $0.50 per pound to prospect P1. P1 declines. When offered, P2 accepts the offer to buy the entire 10 tons at $0.50 per pound. Prospect P3, however, would have been willing to purchase the 10 tons for $0.70 per pound. Thus, Supplier A missed an opportunity to gain $0.20 per pound. For 10 tons (ton=2000 pounds), Supplier A loses $4000.00 (20,000 pounds at $0.20 per pound).

A method of selling not currently used by commodity suppliers/buyers is to use an on-line auction. One of the largest and most well known on-line trading community is available from eBay™ (http://www.ebay.com). An on-line auction is similar to a live auction in that buyers bid for an item and compete against one another to win the right to purchase the item by placing the highest bid. Bidders in on-line auctions can be anywhere around the globe, as long as they are connected to the on-line auction site via a network. Because the bidders are not co-located, on-line auctions typically have a preset start (open) and end (close) time. This allows the bidders to log in to the on-line auction when it is convenient, but does not require them to be present to win. Typical on-line auctions have algorithms implemented by software to determine which bidder is the high bidder, thus eliminating the need for a live auction representative. Since on-line auctions in use today do not have a moderator or auction representative; once a bid has been placed, it is not possible to withdraw the bid, even if it was a mistake.

A number of terms specific to auctions are defined below as a basis for the description provided herein:

English Auction: The English auction format is an ascending-price offering, meaning that, in general, bids must be higher in price than existing bids in order to win an auctioned offering. In an English offering, all offering participants can see the bids placed by other participants. This is known as open-outcry. English offerings can be multi-unit offerings in that a lot can contain one or many units of the item being auctioned. Bidders can bid for all of the items or a portion of them.

Basic rules for English Offerings (although these rules are simpler if the auction has only one lot, such as one railcar):

Each bidding participant is allowed one current bid in the offering at a time.

A subsequent bid from a given user replaces that user's existing bid if it passes validation.

Each bid includes a bid quantity and bid price.

If ore than one (1) item is available for sale, bidders can specify whether they will accept a partial fulfillment of their requested quantity or will accept only the full amount of their requested quantity.

All bids must be equal to or greater than the starting bid of the offering.

The auction defines the minimum bid required based on the offering's starting bid, the quantity available, the currently winning bids, and whether the bidder already has a bid in the offering.

Bidders cannot decrease the price or quantity of a prior bid.

Winning an English Auction: The rules for determining a winning bid (known as the bidding algorithm) in a standard English offering are based on a comparison of price, quantity, and submit time of the bids. A typical algorithm follows:

best Price wins.

a tie in price will be won by the highest bid quantity.

a tie in price and quantity will be won by the earliest bid time.

Reverse Auctions: Reverse, or buy, offerings are somewhat like “want ads”; instead of posting an item for sale, the auction representative posts a notice for an item that a user wishes to buy. Sellers then compete to sell the item at the lowest price. Both English and Dutch formats can be applied to reverse offerings. In a reverse English offering, a buyer begins the offering with an opening price. From this point, the rules are much like that of a standard English offering, but price progression is inverted.

Each seller is allowed one current bid in the offering at a time. A subsequent offer from a given user replaces that user's existing bid if it passes validation. Each bid indicates a quantity and price that the seller is offering. Unless the auction is posted as an “all or nothing” auction, sellers can specify whether they will provide a partial fulfillment of the requested quantity or will provide the full amount of the requested quantity. All bids must be equal to or lesser than the opening price of the offering. The auction defines the maximum bid required based on the offering's opening price, the quantity available, the currently winning offers, and whether the bidder already has a bid in the offering. Bidders cannot increase the price of a prior bid. Also, bidders cannot decrease the quantity of a prior bid.

Open and Close Times: Bidding can begin at the scheduled opening time. An auction will normally close at the scheduled closing time. However, the auction may remain open for an extended period of time if bidding activity continues near the end of the auction. These auction extensions allow bidders to respond to last-minute competing bids.

Opening Price and Reserve Price: The opening price determines the starting price of the auction. The reserve price is a bidding limit used to prevent a sale at a catastrophically low price. The opening price is shown on the bidding screen. The reserve price is not shown.

### BRIEF SUMMARY OF THE INVENTION

It is therefore provided herein a method and system for providing an on-line auction for conducting and facilitating transactions in a commodity goods marketplace or industry. An embodiment of the present invention provides a World Wide Web (“Web”) based auction site for conducting and facilitating transactions in the chemical industry. The auction-based model allows a supplier to sell (or buy) goods closer to a real market prices than the current method of offering the commodity via telephone, facsimile, or electronic mail. Thus, more revenue is realized by the supplier for the same quantity of goods/commodity.

The present invention provides an auction site that provides an on-line virtual community for the exchange of products, equipments and goods. An embodiment of the present invention may be implemented as an industry auction site where goods, products and services specific to a particular industry are substantially continuously offered for sale.

The auction site may form the center of a community that includes, but is not limited to, commodity product suppliers, commodity product users, speculators and industry service providers. The community may exist on many levels and comprise an entire industry on one level and segments of that industry on other levels. The auction site may function as a market maker to facilitate the buying and selling of the commodity goods.

According to the system and method described herein, the auction site provides a location for buyers and sellers of goods, products and equipment to congregate and consummate transactions. In an embodiment of the present invention, the auction site is advantageously implemented as a virtual auction site on the World Wide Web, and the buying/selling process is performed through the use of auction software.

An advantage of the system described herein is that the auction site will provide increased liquidity for industry goods and services. By providing a congregation point for buyers and sellers, the auction site facilitates finding sellers during times of high demand for products, and finding buyers during times of high supply of products.

In another embodiment, the auction site charges a transaction fee, for example as a percentage of the deal price, in order to fund the overhead costs of the auction site, and to provide a return on investment to the party or parties that invest in forming the auction site. As will be understood by those of ordinary skill in the art, members of the community, including buyers/sellers of commodities, as well as outside parties, may be investors in the auction site.

The system for conducting and facilitating transactions has an auction site for conducting and facilitating transactions in a selected industry, for instance the chemical industry as further described below. The auction site is connected to a global computer network, such as a site on a computer network such as one with access to the World Wide Web; a corporate intranet; a government/military network or the like, with the site accessible via a standard Web browser. The auction site is be implemented to enable private auctions.

According to the system and method, an auction representative pre-qualifies users based on pre-determined criteria. After successful pre-qualification, a user may be granted access to a private auction on the auction site. There are typically two (2) types of users of the auction site: (1) auction representatives and (2) bidders.

An auction representative has access to the auction site via an auction representative interface which allows the auction representative to create a new auction and activate it (post it) on the auction site. Based on the desired pool of bidders, the auction representative can create new authorized bidders or authorize current users for the auction site, auction categories, or individual auctions. Once a user/bidder has been created and authorized for an auction, the system automatically sends electronic notification messages to the bidder. Types of messages that might be sent are (a) a reminder to selected bidders for an auction at a pre-determined time prior to the auction open time; (b) a notice to a first bidder when the first bidder is outbid by a second bidder; (c) a message to winning bidders following the close of the auction, notifying each winning bidder of their winning bid; (d) a message to losing bidders following the close of the auction, notifying each losing bidder of their losing bid. The user/bidder may modify his/her profile to select the types of notifications that are to be sent. Further, an electronic message is sent to the posting auction representative identifying winning bidders. One advantage of the system described herein is that the notification messages are time stamped with a user's local time. In other words, if an auction is to begin at 3:00 PM PST, and the user is located in New York, the automatic message reminds the user of an auction beginning at 6:00 PM EDT. This reduces the chance that a user will miss an opportunity because of miscommunications regarding start and end times. This conversion is possible because each user in the auction site system has a corresponding user modifiable profile which holds their default time zone.

The system and method utilizes a user interface to enable interaction between the auction and the users. Time of day information presented in the user interface automatically conforms to the user's preferred time zone. A bidder selects an auction on the auction site from a list of auctions authorized for that bidder. The user does not see auctions that are not authorized. Once connected to the auction, the users compete with bids for an item in the selected auction. A bid is valid and accepted by the system if it meets a pre-determined criteria such as whether (a) the auction is open, (b) a numerical difference between the bid and the current winning bid is greater than a selected threshold, and (c) the bidding user is authorized. A bidder may view previous bids in the selected auction, but cannot see the identity of the competing bidders. An authorized auction representative may see all bidder identities. An auto bid facility is also enabled. An auto bid allows a first user to specify a maximum bid above a current bid, and increases the first user's bid by a pre-specified minimum bid up to the specified maximum bid when a second user outbids the first user.

### DESCRIPTION OF THE DRAWINGS

The accompanying drawings, which are incorporated in and form part of the specification, illustrate the present invention, when viewed with reference to the description, wherein:

FIG. 1 is a block diagram of an auction site available via the World Wide Web;

FIG. 2 is an illustration of a screen in an exemplary user interface, listing authorized auction categories;

FIGS. 3 and 3A illustrate screen shots in an exemplary user interface for listing authorized auctions and status thereof;

FIGS. 4A and 4B illustrate a bidding screen in an exemplary user interface;

FIGS. 5A and 5B illustrate a user profile viewing/editing screen in an exemplary user interface;

FIG. 6 is a block diagram illustrating an exemplary embodiment of the bidding method of the present invention; and

FIG. 7 is a block diagram illustrating an exemplary embodiment of the pre-auction and post-auction features of system and method described herein.

### DETAILED DESCRIPTION OF THE INVENTION

In an exemplary embodiment, the system for conducting and facilitating transactions has an auction site for conducting and facilitating transactions in a selected industry, for instance the chemical industry. The auction site is connected to a global computer network, such as a site on a computer network such as one with access to the World Wide Web; a corporate intranet; a government/military network or the like, with the site accessible via a standard Web browser. The exemplary auction site utilizes private auctions.

In the exemplary embodiment, the community of the system and method is implemented as a “virtual” community in conjunction with the auction site, as a site on a computer network with access to the World Wide Web, for ease of access to the widest number of participants. Currently available hardware platforms, including PC's, minicomputers and mainframes, and currently available operating systems, including UNIX®, Microsoft® Windows™, Apple Macintosh OS and Linux, may be utilized to host the site. (Microsoft® and Windows™ are trademarks of Microsoft Corporation. UNIX® is a registered trademark of UNIX System Laboratories, Inc. Macintosh® is a registered trademark of Apple Computer, Inc.)

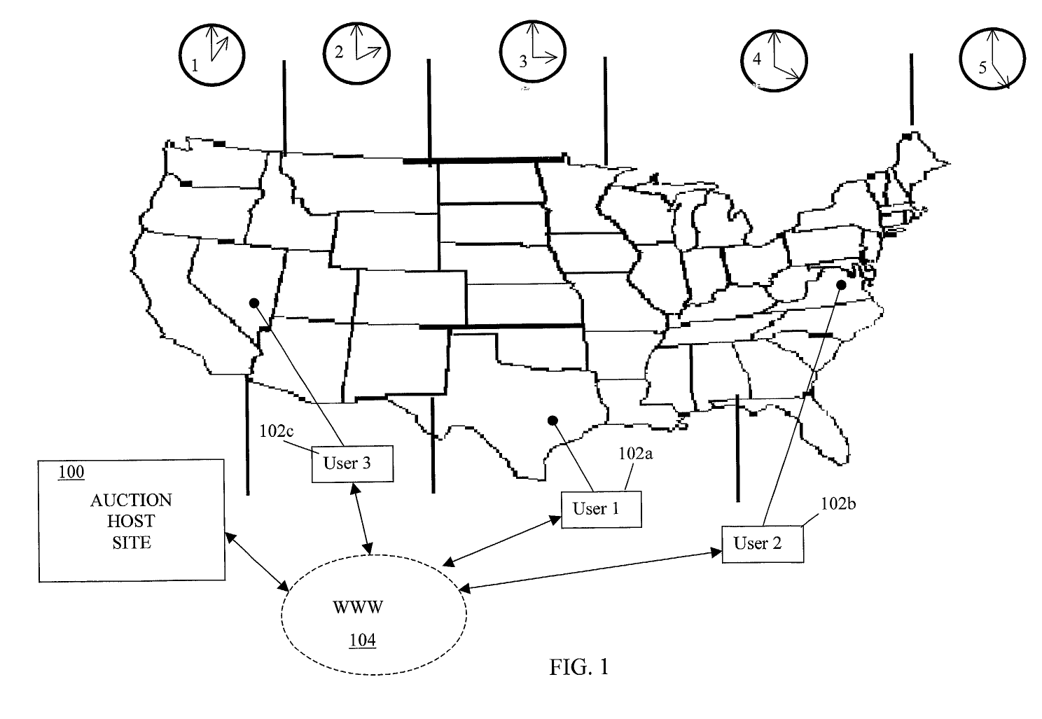

Referring now to the drawings, and in particular to FIG. 1, there is shown a high level block diagram of an exemplary embodiment of the system and method described herein. An auction site 100, physically located in Southern California, is connected to users 1-3 (102a-c) via the Internet 104 using a World Wide Web interface. As illustrated, user 1 is located in central Texas, user 2 is located in northern Virginia, and user 3 is located in Nevada. Thus, if an auction begins at 1 PM PST, only user 3 (102c) will have the same local time as the auction site.

Timing information (start and end times) can be easily misconstrued by auction users. These errors can cause a potential bidder to miss an auction altogether, or a bidder to delay accessing the auction site for a re-bid long enough to miss the opportunity to outbid the current winner. The system, as described herein, automatically converts time of day information to be presented in the user's local time zone format. Thus, if an auction begins at 1 PM PDT, user 1 (102a) is notified that the auction begins at 3 PM CDT, user 2 is notified that the auction will begin at 4 PM EDT and user 3 is notified that the auction will begin at 1 PM PDT.

Auctions on the auction site are by invitation only. This allows the auction representative to pre-qualify potential bidders. Optimally, the only users invited to bid at an auction would be anyone having a need to buy (or is a reverse auction, sell) the item, with significant credit and business relationship with the offering entity. When an auction is anticipated, potential bidders are assigned a username and password, in advance, through an auction representative user interface, that gives them access to the auction schedule and the bidding floor. To participate in an auction, buyers must accept a “Bidder Agreement” which is displayed each time when logging in. This agreement acknowledges that all bids placed in an auction reflect a binding, irrevocable commitment on behalf of the bidder to purchase or sell product at the bid price. Anyone bidding on behalf of another party or entity must demonstrate to the satisfaction of an auction site authority to do so before any bids are placed.

An auction representative having access to the auction site via an auction representative interface creates new auctions and activates them (posts them) on an auction site. Auctions can be categorized and bidders can be placed in a group that has access to all auctions in a specified category of auctions. These categories and user groups are defined and enabled by the auction representatives. Based on the desired pool of bidders, the auction representative can create new authorized bidders or authorize current users for the auction site, auction categories, or individual auctions.

Once a user/bidder has been created and authorized for an auction, the system automatically sends electronic notification messages to the bidder. Types of messages that might be sent are (a) a reminder to selected bidders for an auction at a pre-determined time prior to the auction open time; (b) a notice to a first bidder when the first bidder is outbid by a second bidder; (c) a message to winning bidders following the close of the auction, notifying each winning bidder of their winning bid; (d) a message to losing bidders following the close of the auction, notifying each losing bidder of their losing bid. The user/bidder may modify his/her profile to select each type of notifications that is to be sent. Further, an electronic message is sent to the posting auction representative identifying winning bidders. One advantage of the system described herein is that the notification messages are time stamped with a user's local time. In other words, if an auction is to begin at 3:00 PM PDT, and the user is located in New York, the automatic message reminds the user of an auction beginning at 6:00 PM EDT. This reduces the chance that a user will miss an opportunity because of miscommunications regarding start and end times. This conversion is possible because each user in the auction site system has a corresponding user modifiable profile which holds their default time zone.

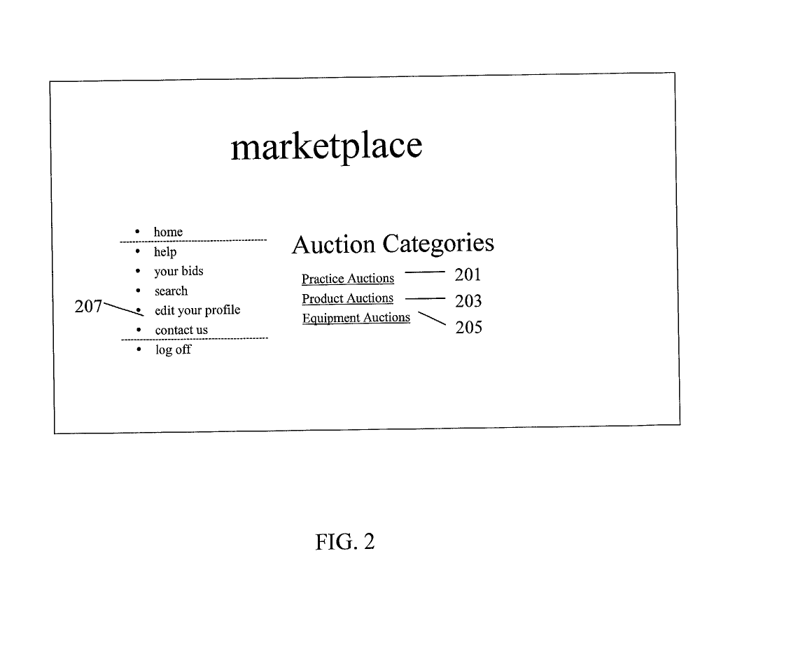

Referring now to FIG. 2, a user/bidder logs on the auction site 100 (FIG. 1) with a username and password. Once the bidder's identity is authenticated, the bidder sees a list of auction categories. In the exemplary embodiment the categories are practice auctions 201, product auctions 203, and equipment auctions 203. It will be apparent to one of ordinary skill in the art that these categories will change based on the industry running the auction site. It will also be apparent to one of ordinary skill in the art that an additional layer of categories could be used to implement several industries on one home page, thus building a multi-layered community of auction sites. Further, different categories of auctions allow a range of users to enter the auction site without being limited to goods of a single industry or commodity base. Only categories that have been authorized for this user's access are shown on the screen. For instance, if a user is only authorized to participate in practice auctions, only the practice auctions link 201 is shown. Thus, not only are the categories of product auctions 203, and equipment auctions 203 not shown, but they are inaccessible to the user.

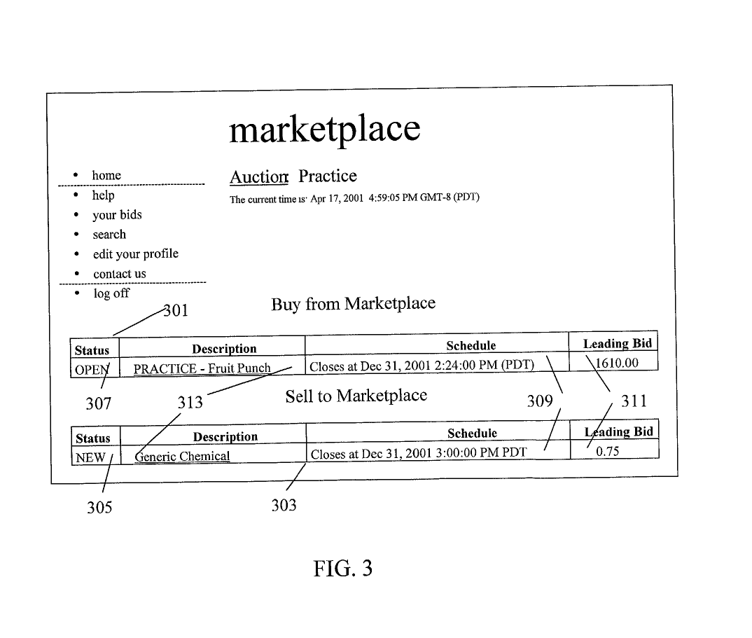

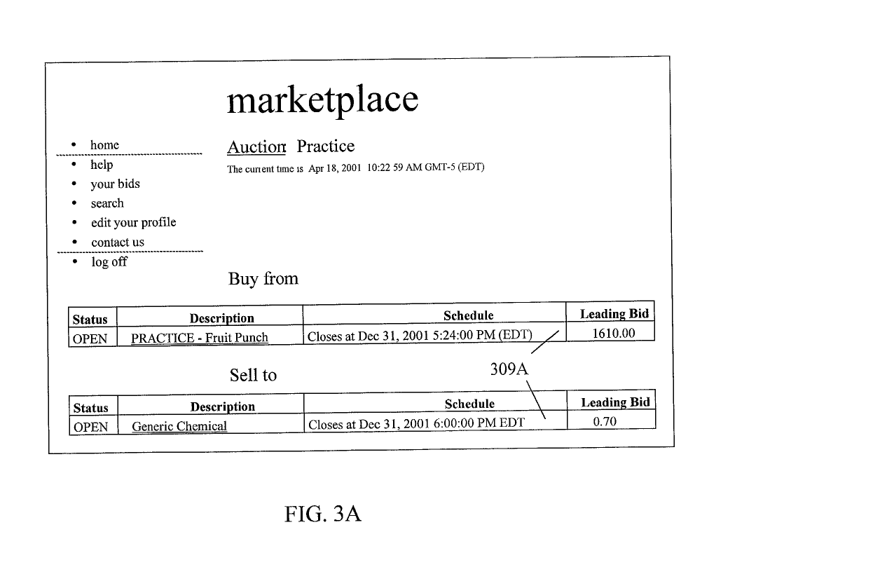

The user may navigate deeper into the auction site by selecting an auction category. Referring now to FIG. 3, within each auction category, the user may find sub-categories (not shown) and specific auctions 301 and 303. When a user sees an auction listed, it will be in a “NEW” 305 or “OPEN” 307 state. “New” indicates that the auction is scheduled to begin sometime in the future. “Open” indicates that the auction is currently open for bids. The scheduled open (start) and close (end) times will be shown also 309. If the auction is open, the leading bid 311 will also be shown on this screen.

One should note that the scheduled auction times 309 are listed in the user's default time zone. If a user changes his default time zone through the modification of the user profile (to be discussed below), then this screen will reflect that change. For example, the Practice—Fruit Punch auction is open and is scheduled to close at Dec. 31, 2001, 2:24 PM PDT. FIG. 3A shows the display seen by the user if the default time zone is set to Eastern Daylight Time. The close date/time for the Practice—Fruit Punch auction 309A now shows Dec. 31, 2001, 5:24 PM EDT. This conversion is performed automatically, and it is transparent to the user in which time zone the auction is actually being held. This feature is a significant value added over the prior art.

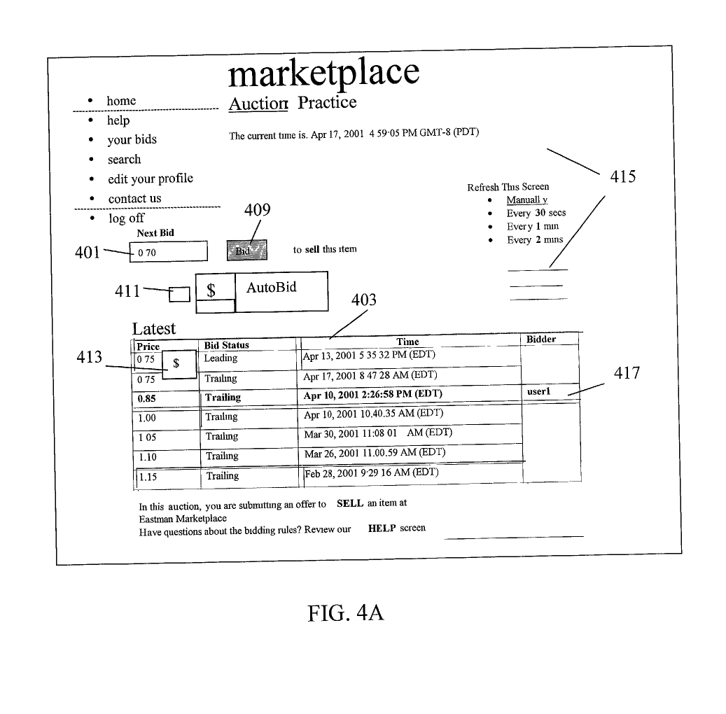

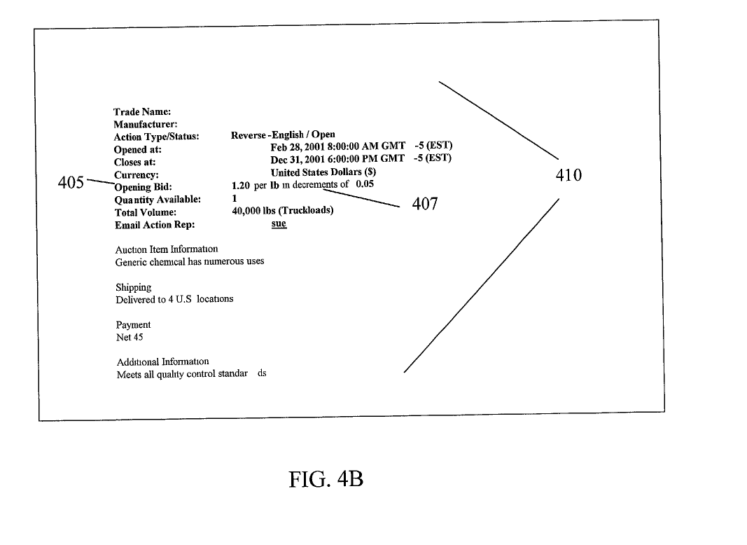

In order to bid on an item, the user clicks on an auction name 313 and the bidding screen is displayed, as shown in FIG. 4A. In an exemplary embodiment, a user must scroll down to the bottom of the page in order to see details regarding this auction and the terms of sale, as shown in FIG. 4B. It will be apparent to one of ordinary skill in the art that the terms and conditions of sale could be located in a separate page that is accessible by a hyperlink, or some other method, with no loss of information to the user. However, the location of the terms and conditions on the same page as the bidding screen effects an “all on one page” tactic to ensure that (a) a printout will list the entire conditions of the auction and (b) the bidder has viewing access to the additional auction information. If the auction is open the user will see a “Next Bid” prompt 401 for placing a bid. Previous bids will be shown in the Latest Bids section 403.

Each auction has an opening bid (starting price) 405 and a minimum Bid Increment (or decrement for offers to sell rather than purchase) 407. The Next Bid box 401 automatically prompts the bidder with the next minimum bid amount. A bidder can accept this default or type in a desired amount and then select the “Bid” button 409 to place a bid.

If “Auto Bids” are allowed in this auction, the bidder will see an Auto Bid checkbox 411 beneath the Next Bid prompt 401. This box is checked if the bidder wants the bid placed as an Auto Bid. Auto Bids are a special type of bid designed to save the bidder time and money, and to increase the bidder's chance of winning. When a bidder places an Auto Bid in an English auction, the bidder is specifying the maximum that he/she is willing to pay for the auction item. Auto Bids should be used when a maximum purchase price the bidder is willing to pay for an item is known in advance. Any Auto Bid will have a special symbol 413 beside it in the “Latest Bids” section. Moreover, a bidder does not need to remain logged in to the auction site if an Auto Bid was placed. The system continues to place bids for the auto bidding bidder up to the maximum specified, and at the minimum interval when the auto bidder has been outbid.

Auto Bids are ranked, as are all competing bids to determine the winning bid. If two bidders offer the same Auto Bid amount, the following rules govern:

(1) best price wins.

(2) a tie in price will be won by the highest bid quantity.

(3) a tie in price and quantity will be won by the earliest bid time. While an authorized auction representative can see which users are bidding in an auction (past and current bids), the auction representative cannot see a specific bidder's maximum Auto Bid amount. The maximum AutoBid is intentionally hidden to protect the bidding strategy and privacy of the bidder. Further, the system will send “Outbid”, “Auction Win”, or “Auction Loss” e-mail notifications throughout the auction for Auto Bids, just as it does with a regular bid.

Most auctions will involve only one (1) item for sale. However, if an auction contains multiple quantities, a bidder can specify the number desired in a quantity prompt (not shown). If a bidder checks Full-Quantity-Only box, an all-or-nothing bid is indicated. This option can be used if the bidder must have the complete quantity bid.

Once a bid has been placed, a confirmation screen is displayed acknowledging that the bid has been accepted. Only valid, winning bids are accepted. If the bid is not accepted, an explanation screen is displayed for the bidder to explain why the bid was not allowed. The bidder can then go back to the bidding screen to correct the bid, or view the latest status.

The information on the bidding screen is updated each time the screen is newly displayed. Optionally, a user can select an alternate refresh rate 415. The exemplary embodiment offers the options of a manual refresh rate, or every 30 seconds, every one minute, or every 2 minutes. It will be apparent to one of ordinary skill in the art that other refresh rates can be offered to a user, including a user defined rate. If the user's refresh rate is set to manual, the Web browser “Refresh” button must be selected to ensure the latest bidding activity is displayed. In other cases, the bidding activity is not older than the selected refresh rate. One should note that selecting an auto refresh rate will not speed up a slow network connection.

Once accepted, the user's bid will appear in the Latest Bids section 403. In multi-item auctions, the quantity column (not shown) will show data in the form of “a/b” where “a” is how many items the bidder is currently Winning and “b” is how many items the bidder originally requested. A bidder will also see his/her username beside the bid 417. The bidder will not see the username of other bidders.

In an alternative embodiment, the user may bid for an item to be delivered from one of several pre-selected locations. For instance, several warehouses may be used to store an item. A bidder may wish to receive the item from a specific location, for a variety of reasons (e.g., shipping costs, quality control, etc.). Thus, the delivery location will factor in to the determination of whether a bid is accepted. An additional charge (or rebate) may be associated with various locations, as well, to account for different costs to produce or ship the items.

An auction will close at it's scheduled close time. Some auctions may be setup for automatic time extension to handle the possibility that bidding will continue in the final minutes of the auction. If this feature is enabled, the exact extension behavior will be explained in the auction invitation email message. The auction will continue to extend until bidding activity subsides and the auction closes. In this way, “snipers”, or users who initiate a winning bid moments before end time, in an attempt to outbid others and succeed in the bid, are thwarted. Thus, there is no disincentive to bidding early.

In the exemplary embodiment, the following events prompt a notification to be automatically sent by electronic mail (e-mail) to appropriate the user: (a) when a new auction is created; (b) when an auction opens; (c) when your bid has been outbid by another bidder; (d) when the user has won an auction; and (e) when the user has lost an auction. In alternative embodiments, the users can elect to disable any of these email notifications in their user profile. If a user's e-mail address changes, the user's profile can also be updated with the new address, thereby avoiding loss of e-mail notifications.

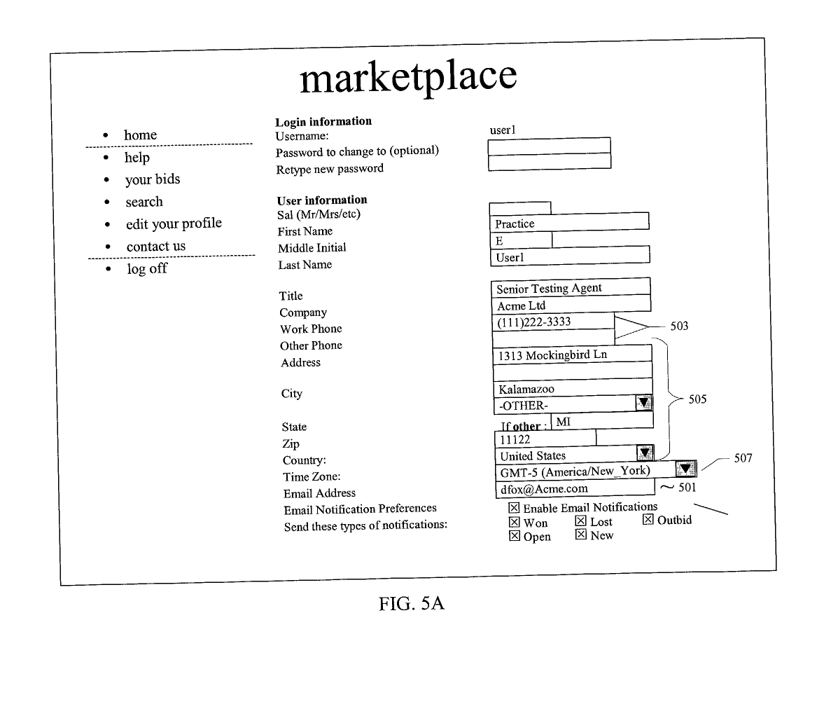

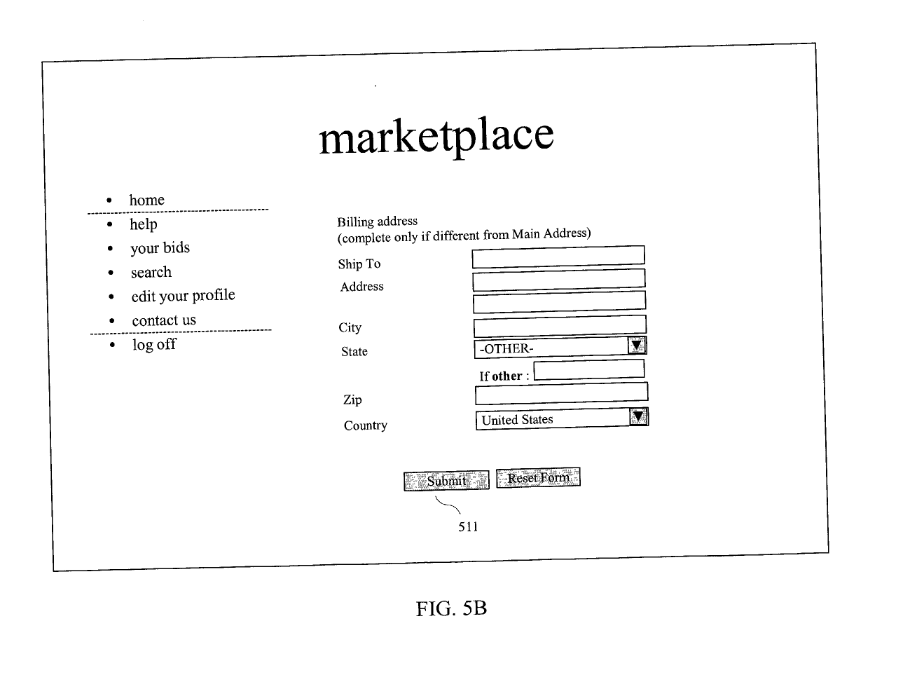

Referring now to FIGS. 5A and 5B, there is shown a screen for viewing and editing a user's profile. A user profile contains many items that control the user's account and prescribes preferences at the auction site. By clicking on “Edit Your Profile”, as shown in FIG. 2 (207), a user can change his/her email address 501, phone number 503, mailing address 505, time zone 507, and choice of email notifications 509, etc. The desired items are modified and then the “Submit” button 511 at the bottom of the screen is selected. In the exemplary embodiment, profile modifications take effect immediately. In alternative embodiments, a review or confirmation process might be implemented prior to a requested modification.

One advantage of the system and method described herein is the offline auction review feature. A typical on-line auction is not moderated or reviewed after closing. Thus, in a typical auction, the winning bidder at closing is automatically notified of the win, and all other bidders are notified of a loss. In the present system and method, an auction representative is optionally given the opportunity to review the final auction bids before the “Won” and “Loss” e-mail notices are sent by the system. When offline auction review is enabled, the auction will close as usual. However, the winning and losing e-mail notices will be temporarily delayed while the auction representative reviews the final bids for completeness and accuracy. After the bids have been reviewed, the auction representative will finalize the auction and the e-mails will be sent. This feature is a significant value added over the prior art.

Another advantage of a moderator/auction representative is that erroneous bids can be cancelled by the auction representative. Once a bidder has realized that an erroneous bid has been made, the bidder sends a request to the auction representative to erase the bid. The auction representative has the authorization to see and modify all bids and their corresponding bidders. If a bidder seems to abusing this capability, they can be blocked from the auction site (or individual auctions) either temporarily or permanently (e.g., disqualified).

In another embodiment, the on-line community comprises the auction sites and links to other services used by the community. For instance, is the community or an individual auction is related to the chemical industry, a link might be added to the bidding screen that enables the bidder to select a delivery carrier specializing in shipping hazardous chemicals. A carrier such as ShipChem might be necessary to transport chemical products, or the bidder might prefer United Parcel Service, Federal Express, or another commercial carrier, depending on the items to be shipped. When the winning bidder selects this option, all relevant data is automatically sent to the carrier (i.e., type of good, quantity of good, warehouse location, destination, special instructions, etc.). This has the advantage that the carrier immediately receives the appropriate shipping information and the bidder does not have to re-enter the data into a separate on-line system.

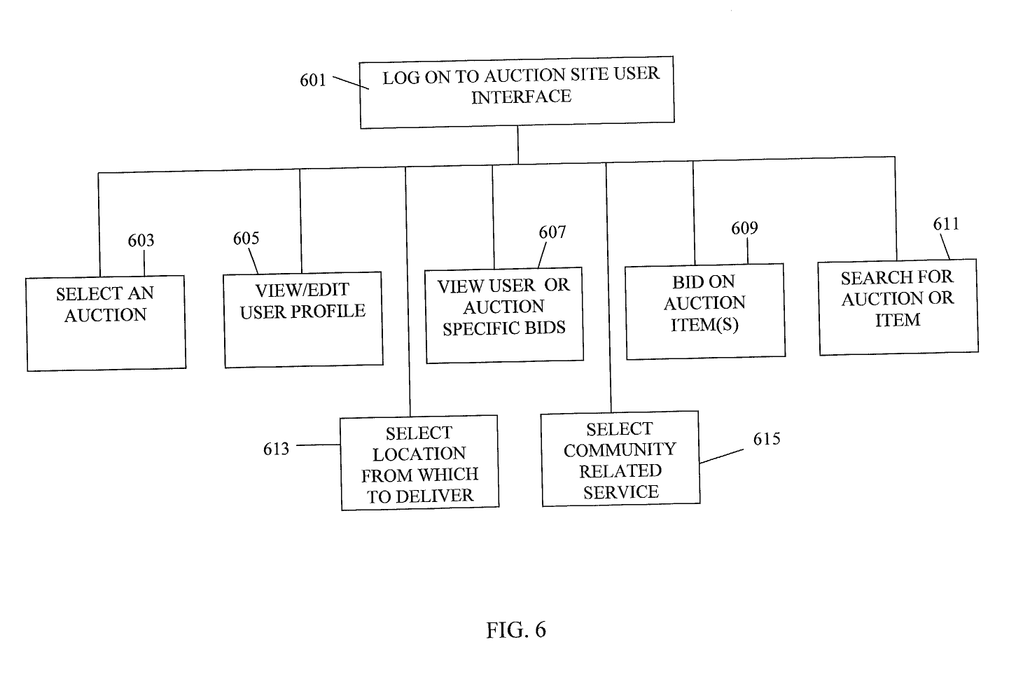

Referring now to FIG. 6, there is shown is a block diagram illustrating an exemplary embodiment of the bidding method of the present invention. An authorized user (bidder) logs on to the auction site through a user interface. In the exemplary embodiment, the user interface is a accessed over a global network using a standard Web browser. The user logs on the auction site in block 601 by providing a username and password for authentication. Once logged on, the user has several options, typically presented as a menu or hot buttons to the side of the screen. It will be apparent to one of ordinary skill in the art that the available user options can be presented in a variety of ways using menus, hyperlinks and a series of related Web pages, or screens.

In order to bid on an item, the user must select an auction in block 603 from a list of available and authorized auctions. The user may see a single list of auctions, or may be directed to a number of auction “rooms” or categories, which will contain lists of related auctions to which the user has been granted access. The user will see only those auctions, or auction rooms (categories) to which he/she has been granted access. Once there, the user can view current and previous auction bids (block 607), or place a new bid (block 609). As discussed above, a user can place an exact bid or an auto bid. The user cannot trump his/her own bid, e.g., if the user has already placed the winning bid, that same user cannot bid again until another user places a winning bid.

If the user has been granted access to many auctions, it may be difficult to find a specific auction among the many different auction rooms or categories. Therefore, a search feature is available (block 611). When the user selects the search option, an entry screen is presented which allows the user to search for either a specific item or a specific auction. Search criteria available for searching includes auction name, item name, open time, close time, auction id, item id, and auction quantity. It will be apparent to one of ordinary skill in the art that other criteria specific to an auction may be searched as well, for instance, location of warehouse, industry of interest, etc. Regardless of the search method used, only those authorized auctions will appear in the search results list. The list of auctions found in the search will typically be presented as hyperlinks so the user can navigate directly to a desired auction.

At any time, the user may select the option to edit his/her profile (block 605), as described above. The user interface is accessible from any computer on the global network, as long as the username and password are entered. An example of a profile parameter that a user might want to modify is the local time zone. A user might travel frequently between or among more than one office, where the offices are in different time zones. Therefore, the user may wish the time zones in the user profile to be set to the local time of wherever the user is logging in, at the moment. This feature reduces the risk of a user missing an auction because he/she forgot to add or subtract hours from the posted start and end times of an auction. All screens showing time of day information and e-mail notifications will be automatically adjusted to the time specified in the user profile.

In an alternative embodiment, the user will also be able to select a location from which to deliver the item(s) bid on (block 613). This feature is an integral part of the bidding screen and can allow multiple users to concurrently maintain winning bids, providing that the items on which they bid are from different locations.

In another alternative embodiment, the auction site is part of a larger on-line community. The on-line community may be directed to a single industry or multiple related or unrelated industries. An advantage of the user access feature is that users may not be aware that other industries are implemented in the same community because a user sees only those categories, or areas of the Web site, that are authorized. Thus, the user in the chemical industry bidding on polyvinyl chloride will not know that there are also users of the food industry bidding on fruit punch. However, because the auction is integrated with the on-line community, the user will be able to select community or industry related services (block 615) through the user interface. For instance, a winning bidder may choose to select the shipping carrier from the community. When this service is selected, all relevant data of the item bid is sent to the carrier automatically, saving time for the user and preventing delivery risks due to missing or incorrect data being manually re-entered by the user.

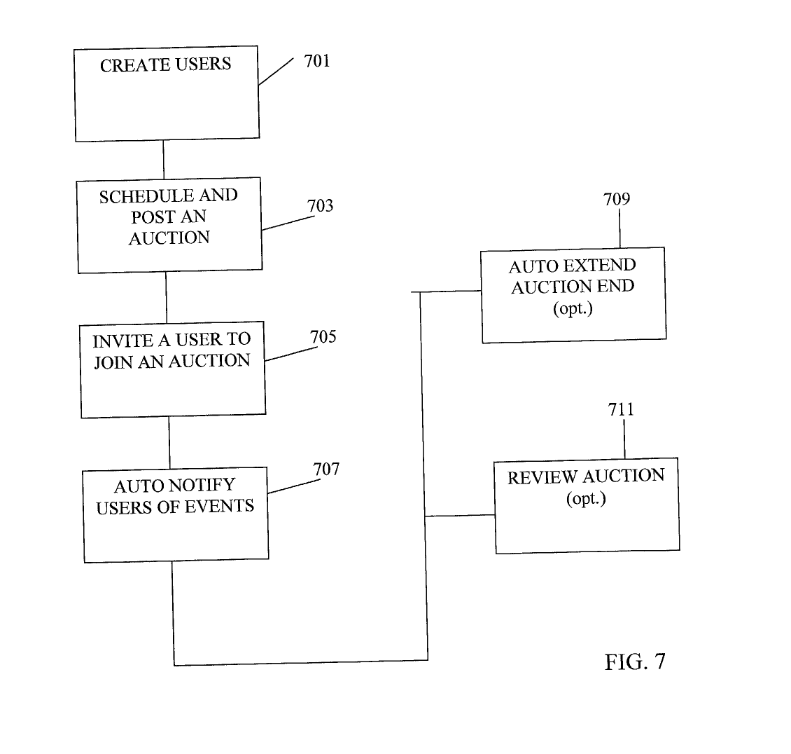

The access and automatic notification features are made available through careful planning by an auction representative. Referring now to FIG. 7, there is shown a block diagram illustrating an exemplary embodiment of the pre-auction and post-auction features of the system and method described herein. Before an auction is scheduled, potential bidders are identified by the auction representative. A username and password are created in the system for each potential bidder (block 701), if not already created for a prior auction. The users are then associated with categories and/or individual auctions to which they are granted access. An auction representative schedules and posts an auction to the site in block 703. The auction is associated with an item, or items, for sale or to buy, a start time, an end time, and a set of auction specific rules, i.e., minimum bid, reserve bid, minimum bid increment (decrement for reverse auctions), etc.

When a user has been granted access to a scheduled auction, the user is automatically notified with an invitation message in block 705. The system automatically opens the auction at the scheduled time, and an additional reminder/invitation message is sent to the authorized users via e-mail. Throughput the auction, a variety of auction events will trigger additional automatic e-mail messages to the users authorized for that auction in block 707, as described above. The system will automatically close an auction at the scheduled end time.

In a further embodiment of the method and system, an automatic extend (“auto extend”) feature is available in block 709. This feature is enabled during the scheduling phase of the auction, but is not acted upon until the scheduled end time. If bidders make bids very close to the end of the auction, the auction is automatically extended by a predetermined amount of time. This prevents what is commonly referred to as “sniping,” e.g., waiting until moments before the auction closes to place a small incremental winning bid and preventing competing bids to be entered (the auction ends before competitors can place a bid).

Another embodiment allows an auction representative to review the auction results in block 711, before automatic winning and losing notifications are sent to the users. This allows human intervention to ensure fair and proper execution of the auction.

Various preferred embodiments of the invention have been described in fulfillment of the various objects of the invention. It should be recognized that these embodiments are merely illustrative of the principles of the invention. Numerous modifications and adaptations thereof will be readily apparent to those skilled in the art without departing from the spirit and scope of the present invention.

1. A system for conducting and facilitating transactions in a commodity goods marketplace or industry, comprising:
an auction site for conducting and facilitating transactions in a selected industry, the auction site connected to a global computer network and accessible via a standard Web browser, wherein the auction site enables private auctions;
a pre-qualifier for pre-qualifying users, wherein after successful pre-qualification, a user is granted access to a private auction on the auction site;
a message notifying delivery component for automatically sending electronic messages to users, the electronic messages notifying the users of information specific to an auction, wherein time of day information is presented in a user's local time zone;
an auction representative interface for:
(1) posting an auction to the auction site by an authorized auction representative,
(2) creating users,
(3) managing users, and
(4) initiating invitations to users to join a scheduled auction; and a user interface for:
(1) selecting an auction on the auction site, where a list of auctions from which a user selects an auction comprises auctions to which the user has been invited,
(2) bidding for an item in a selected auction, wherein a bid is valid if it meets a predetermined criteria, the predetermined criteria comprising a determination of whether (a) the bid is made within a selected time interval, (b) a numerical difference between the bid and a current winning bid is greater than a selected threshold, and (c) the bidding user is authorized, and wherein only valid bids are accepted by the auction site;
(3) viewing previous bids in a selected auction, where for a viewed bid, information used to identify the user who placed the viewed bid remains hidden to other users, but is open to authorized auction representative personnel, and
(4) enabling a first user to “auto bid” during an auction, where an auto bid allows the first user to specify a maximum bid above a current bid, and increases the first user's bid by a pre-specified minimum bid up to the specified maximum bid when a second user outbids the first user,
wherein, if presented in the user interface, time of day information is presented in a user's local time zone.

2. A system as recited in claim 1, wherein the message notifying delivery component automatically sends an invitation to a user who has been selected as a bidder for an auction when the auction is created, wherein the user is pre-qualified and created as a user in the auction site prior to being selected as a bidder.

3. A system as recited in claim 2, wherein the message notifying delivery component automatically sends a reminder to selected bidders for an auction at a pre-determined time prior to the auction open time.

4. A system as recited in claim 2, wherein the message notifying delivery component automatically sends a notice to a first bidder when the first bidder is outbid by a second bidder.

5. A system as recited in claim 2, wherein the message notifying delivery component automatically sends a message to winning bidders, notifying the winning bidders of the winning bids.

6. A system as recited in claim 2, wherein the message notifying delivery component automatically sends a message to losing bidders, notifying the losing bidders of the losing bids.

7. A system as recited in claim 2, wherein an auction representative posts the auction via the auction representative interface and the message notifying delivery component automatically sends a message to the posting auction representative identifying winning bidders.

8. A system as recited in claim 2, wherein an auction is created with a review feature, the review feature causing a review delay requiring interaction and review by an auction representative before the message notifying delivery component automatically sends a message to bidders with a status notification indicating whether a bidder has won or lost a bid.

9. A system as recited in claim 1, wherein a user is presented with a selection of auctions for which the user is authorized and unauthorized auctions are not viewable by the user, and wherein the user is identified by a username and password to determine authorization levels.

10. A system as recited in claim 1, where a plurality of auctions are created for the auction site, the plurality of auctions being segregated into distinct groups, wherein a user has access to all auctions in an authorized group.

11. A system as recited in claim 1, wherein a modifiable profile corresponds to each user, the user being capable of modifying the corresponding profile via the user interface.

12. A system as recited in claim 11, wherein the modifiable user profile identifies a default time zone for the corresponding user.

13. A system as recited in claim 11, wherein a set of desired electronic messages is selected by a user via the modifiable user profile.

14. A system as recited in claim 1, wherein a history of winning and losing bids by a user is viewable to the bidding user via the user interface.

15. A system as recited in claim 1, wherein the user interface allows a user to search the auction site for a selected auction.

16. A system as recited in claim 15, wherein search criteria for the auction search comprises at least one item selected from the group consisting of: auction name, item name, open time, close time, auction id, item id, and auction quantity.

17. A system as recited in claim 1, wherein bids identical in price are ranked first based on quantity and then on time.

18. A system as recited in claim 1, wherein the user interface presents a list of bids for an auction at a user selectable refresh rate.

19. A system as recited in claim 1, wherein a user with a winning bid selects a location from which to ship the auctioned item.

20. A system as recited in claim 1, wherein an auction is created with a start time and an end time, the end time being automatically extended by a pre-determined amount of time when a user places a valid bid within a pre-determined amount of time immediately prior to the scheduled end time.

21. A method for enabling transactions in a commodity goods marketplace or industry, comprising:
posting, by an authorized user (auction representative), an auction to an auction site for conducting and facilitating transactions in a selected industry, the auction site connected to a global computer network and accessible via a standard Web browser, wherein the auction site enables private auctions, and wherein posting further comprises scheduling the auction;
creating users, by an auction representative, on the auction site, each user being a member of at least one group, wherein each group has access to at least one selected auction, and wherein a user has access to auctions associated with a user's group, but does not have access to auctions not associated with the user's group, and wherein users are for pre-qualified before being granted access to a private auction on the auction site;;
managing users, by an auction representative, for adding, modifying and deleting users from the auction site and selected auctions;
initiating invitations to users to join a scheduled auction; and
automatically notifying users of auction events by sending electronic messages to the appropriate users, wherein time of day information in the message is presented in a user's local time zone.

22. A method for conducting and facilitating transactions in a commodity goods marketplace or industry, comprising:
posting, by an authorized user (auction representative), an auction to an auction site for conducting and facilitating transactions in a selected industry, the auction site connected to a global computer network and accessible via a standard Web browser, wherein the auction site enables private auctions, and wherein posting further comprises scheduling the auction;
creating users, by an auction representative, on the auction site, each user being a member of at least one group, wherein each group has access to at least one selected auction, and wherein a user has access to auctions associated with a user's group, but does not have access to auctions not associated with the user's group, and wherein users are for pre-qualified before being granted access to a private auction on the auction site;;
managing users, by an auction representative, for adding, modifying and deleting users from the auction site and selected auctions;
initiating invitations to users to join a scheduled auction;
automatically notifying users of auction events by sending electronic messages to the appropriate users, wherein time of day information in the message is presented in a user's local time zone;
selecting an auction on the auction site, by a bidding user (bidder) where a list of auctions from which the bidder selects an auction comprises auctions to which the bidder has been invited and granted access;
bidding for an item in a selected auction, by a bidder, wherein a bid is valid if it meets a pre-determined criteria, the predetermined criteria comprising a determination of whether (a) the bid is made within a selected time interval, (b) a numerical difference between the bid and a current winning bid is greater than a selected threshold, and (c) the bidding user is authorized, and wherein only valid bids are accepted by the auction site;
viewing previous bids in a selected auction, where for a viewed bid, information used to identity a bidder who placed the viewed bid remains hidden to other bidders, but is open to authorized auction representatives; and
enabling a first bidder to “auto bid” during an auction, where an auto bid allows the first bidder to specify a maximum bid above a current bid, and increases the first bidder's bid by a pre-specified minimum bid up to the specified maximum bid when a second bidder outbids the first bidder,
wherein, if presented to a bidder, time of day information is presented in the bidder's local time zone.

23. A system as recited in claim 22, wherein automatically notifying users sends an invitation to a user who has been selected as a bidder for an auction when the auction is created, wherein the user is pre-qualified and created as a user in the auction site prior to being selected as a bidder.

24. A system as recited in claim 23, wherein automatically notifying users sends a reminder to selected bidders for an auction at a pre-determined time prior to the auction open time.

25. A system as recited in claim 23, wherein automatically notifying users sends a notice to a first bidder when the first bidder is outbid by a second bidder.

26. A system as recited in claim 23, wherein automatically notifying users sends a message to winning bidders, notifying the winning bidders of the winning bids.

27. A system as recited in claim 23, wherein automatically notifying users sends a message to losing bidders, notifying the losing bidders of the losing bids.

28. A system as recited in claim 22, wherein posting an auction is performed using an auction representative interface and once posted, the auction representative interface creating an event which triggers an automatic message for automatically notifying the posting auction representative of winning bidders of the posted auction.

29. A system as recited in claim 22, further comprising reviewing results of an auction, by an auction representative, wherein if reviewing is enabled, automatically notifying users of auction events is delayed until the reviewing is complete.

30. A system as recited in claim 22, wherein a bidder is presented with a selection of auctions for which the bidder is authorized and unauthorized auctions are not viewable by the bidder, and wherein the bidder is identified by a username and password to determine authorization levels.

31. A system as recited in claim 22, wherein posting an auction is repeated for a plurality of auctions, each of the plurality of auctions being segregated into distinct groups, wherein a user has access to all auctions in an authorized group.

32. A system as recited in claim 22, wherein creating a user further comprises:
generating a modifiable profile corresponding to the user, the profile initially containing default information relating to the user, the user being capable of modifying the user's corresponding profile via a user interface.

33. A system as recited in claim 32, wherein the modifiable user profile identifies a default time zone for the corresponding user.

34. A system as recited in claim 32, wherein a set of desired electronic messages is selected by a user via the modifiable user profile.

35. A system as recited in claim 22, further comprising viewing a history of winning and losing bids, by a user, via a user interface.

36. A system as recited in claim 22, further comprising searching for a selected auction in the auction site via a user interface.

37. A system as recited in claim 36, wherein search criteria for the searching comprises at least one item selected from the group consisting of: auction name, item name, open time, close time, auction id, item id, and auction quantity.

38. A system as recited in claim 22, further comprising ranking bids placed by bidders, wherein bids identical in price are ranked first based on quantity and then on time.

39. A system as recited in claim 22, further comprising selecting a refresh rate for bidding screens, by a user, wherein a bidding screen presents a list of current and previous bids in an auction.

40. A system as recited in claim 22, further comprising selecting, by a winning bidder, a location from which to ship the auctioned item.

41. A system as recited in claim 22, further comprising automatically extending a pre-determined scheduled end time for an auction, by a pre-determined amount of time, when a bidder places a valid bid within a pre-determined amount of time immediately prior to the scheduled end time.
